(19) United States
(12) Patent Application Publication
(10) Pub. No.: US 2020/0202302 A1
(43) Pub. Date: Jun. 25, 2020

(54) CLASSIFYING AND ROUTING ENTERPRISE INCIDENT TICKETS

(71) Applicant: Microsoft Technology Licensing, LLC, Redmond, WA (US)

(72) Inventors: Mehul Kamlesh Rathod, Fremont, CA (US); Abhishek Singh, San Jose, CA (US)

(21) Appl. No.: 16/230,926

(22) Filed: Dec. 21, 2018

(51) Int. Cl. G06Q 10/10; G06F 17/27; G06K 9/62

(52) U.S. Cl. CPC G06Q 10/107; G06K 9/6218; G06F 17/278

(57) ABSTRACT

The disclosed embodiments provide a system for classifying and routing incident tickets. During operation, the system obtains incident categories containing clusters of related words in incident tickets, wherein the clusters of related words are generated based on embeddings of words in the incident tickets. Next, the system generates match scores between an incident ticket and the incident categories based on occurrences of the related words in the incident ticket. The system then assigns, based on the match scores, the incident ticket to an incident category in the incident categories. Finally, the system generates output for routing the incident ticket within an incident management system according to the incident category

### BACKGROUND

### Field

The disclosed embodiments relate to techniques for processing incident tickets. More specifically, the disclosed embodiments relate to techniques for classifying and routing enterprise incident tickets.

### Related Art

Analytics may be used to discover trends, patterns, relationships, and/or other attributes related to large sets of complex, interconnected, and/or multidimensional data. The discovered information may be used to gain insights and/or guide decisions and/or actions related to the data. For example, business analytics may be used to assess past performance, guide business planning, and/or identify actions that may improve future performance

In particular, text analytics may model and structure text to derive relevant and/or meaningful information from the text. For example, text analytics techniques may be used to perform tasks such as categorizing text, identifying topics or sentiments in the text, determining the relevance of the text to one or more topics, assessing the readability of the text, and/or identifying the language in which the text is written. In turn, text analytics may be used to mine insights from large document collections, which may improve understanding of content in the document collections and reduce overhead associated with manual analysis or review of the document collections.

### BRIEF DESCRIPTION OF THE FIGURES

FIG. 1 shows a schematic of a system in accordance with the disclosed embodiments.

FIG. 2 shows a flowchart illustrating a process of classifying and routing enterprise incident tickets in accordance with the disclosed embodiments.

FIG. 3 shows a flowchart illustrating a process of generating incident categories for incident tickets in accordance with the disclosed embodiments.

FIG. 4 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

Enterprise systems are commonly supported by Information Technology (IT) service management systems that allow users to file incident tickets related to IT service issues, receive assistance in handling or resolving the issues, and track the progress of the issues until the issues are resolved. To expedite resolution of the issues, an IT service management system includes features and/or mechanisms for routing incident tickets for the issues to agents or groups of agents with experience and/or expertise in handling the issues. The agents then carry out workflows and/or interface with the users to resolve the issues and close the incident tickets.

In one or more embodiments, routing of incident tickets is performed in a data-driven manner, in which the content of the incident tickets is analyzed for patterns and/or semantic relationships among words in the incident tickets and used to perform classification and routing of subsequent incident tickets. For example, a word embedding model may be created from words in the incident tickets, and embeddings produced by the word embedding model may be used to cluster semantically related or similar words into incident categories. Match scores between the incident categories and a new incident ticket may then be calculated, and the incident category that best matches the content of the new incident ticket may be assigned to the incident ticket. The incident ticket may then be routed to an agent or a group of agents associated with the incident category for handling and resolution of the corresponding incident.

By identifying and categorizing semantic similarities among words in incident tickets and performing classification and routing of the incident tickets based on the semantic similarities, the disclosed embodiments may perform incident management in the context of organizations and/or domains in which the incidents occur, thereby improving the accuracy and efficiency with which the incident tickets are routed and handled. In contrast, conventional techniques may perform manual, generic, and/or rule-based classification of the incident tickets, which can be erroneous and delay subsequent resolution of the corresponding issues. Consequently, the disclosed embodiments may improve computer systems, applications, user experiences, tools, and/or technologies related to incident classification and/or IT service management.

### Classifying and Routing Enterprise Incident Tickets

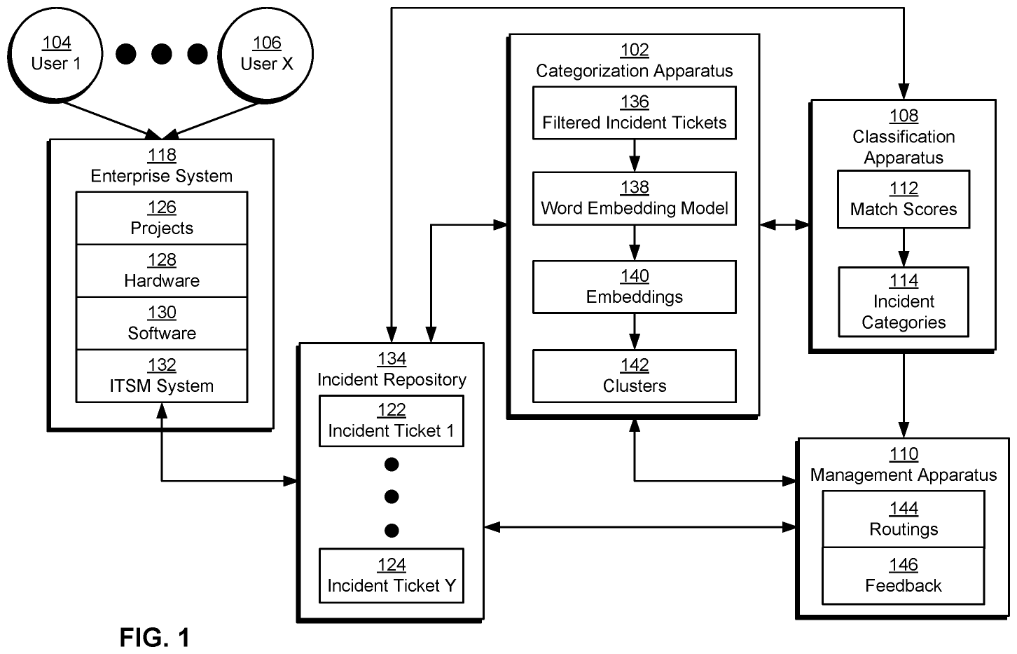

FIG. 1 shows a schematic of a system in accordance with the disclosed embodiments. More specifically, FIG. 1 shows an incident management system that processes incident tickets (e.g., incident ticket 1 122, incident ticket y 124) associated with an enterprise system 118.

Enterprise system 118 supports processes, information flows, reporting, analytics, and/or other types of operations in an organization. As shown in FIG. 1, users (e.g., user 1 104, user x 106) within the organization may develop, interact with, and/or utilize projects 126, hardware 128, and/or software 130 in enterprise system 118 to access the functionality of enterprise system 118.

For example, enterprise system 118 may include a number of custom, specialized, and/or internal projects 126 related to products, services, and/or processes that are available within or outside the organization. Enterprise system 118 may also include hardware 128 such as personal computers, laptop computers, workstations, servers, switches, routers, storage, mobile devices, telephones, printers, and/or other electronic devices or equipment that are used by individual users and/or that host applications or services shared by multiple users. Enterprise system 118 may additionally include software 130 that satisfies needs of the organization, such as needs related to communication, accounting, billing, content management, customer relationship management (CRM), business management, identity management, security, project management, manufacturing, and/or data backup or management.

Enterprise system 118 also includes an Information Technology Service Management (ITSM) system 132 that assists users with service requests, incidents, and/or other queries or issues associated with other parts of enterprise system 118. Within ITSM system 132, user issues with projects 126, hardware 128, and/or software 130 are reported and tracked using incident tickets (e.g., incident ticket 1 122, incident ticket y 124) filed by the users. For example, a user may submit an incident ticket for an issue through an IT service portal, help desk, phone number, chat module, and/or another mechanism provided by ITSM system 132. The issue may include, but is not limited to, a software bug, a disruption in service, an outage, a crash, an authentication issue, a hardware issue, and/or another problem related to access to or use of projects 126, hardware 128, software 130, and/or other components of enterprise system 118. As a result, the incident ticket may include a description of the issue and/or names of projects 126, hardware 128, software 130, and/or other components of enterprise system 118 affected by or related to the issue.

After an incident ticket is received, ITSM system 132 stores the incident ticket in an incident repository 134. For example, ITSM system 132 may create and/or persist a record of the incident ticket in a database, flat file, distributed filesystem, issue-tracking system, bug-tracking system, and/or another data store providing incident repository 134. ISTM system 132 then routes the incident ticket to an agent or group of agents for resolution of the corresponding issue.

In one or more embodiments, the system of FIG. 1 includes functionality to improve processing and resolution of incident tickets in ITSM system 132 by classifying and routing the incident tickets based on the context and/or domain associated with enterprise system 118. For example, the system may map issues described in the incident tickets to code names of projects 126, types of hardware 128 and/or software 130, and/or other components that are unique to enterprise system 118.

First, a categorization apparatus 102 generates filtered incident tickets 136 from incident tickets in incident repository 134. Filtered incident tickets 136 include content from incident tickets that has been filtered to remove certain types of words and/or inflections. For example, categorization apparatus 102 may generate filtered incident tickets 136 by performing stemming of words in the incident tickets. Categorization apparatus 102 may also, or instead, remove infrequent words (e.g., words that appear less than 100 times in a large set of incident tickets) from the incident tickets to produce filtered incident tickets 136. Categorization apparatus 102 may also, or instead, create filtered incident tickets 136 by removing stop words such as high-frequency words (e.g., articles, pronouns, common verbs, greetings, etc.), names, locations, and/or numbers from the incident tickets.

Next, categorization apparatus 102 creates a word embedding model 138 from filtered incident tickets 136 to capture patterns and/or semantic relationships among words in filtered incident tickets 136. For example, categorization apparatus 102 may create a separate “document” from a short description and/or full description in each filtered incident ticket. Categorization apparatus may then train a word2vec model to output embeddings 140 in a vector space based on sequences of words in the set of documents representing filtered incident tickets 136. As a result, words that share common contexts in filtered incident tickets 136 may be closer to one another in the vector space of embeddings 140 than words that are used in different contexts within filtered incident tickets 136.

Categorization apparatus 102 uses embeddings 140 produced by word embedding model 138 to generate clusters 142 of related words in filtered incident tickets 136. For example, categorization apparatus 102 may use a k-means clustering technique and/or another clustering technique to partition embeddings 140 into a certain number of clusters 142 based on measures of distances (e.g., cosine similarities, Euclidean distances, Jaccard similarities, etc.) between or among embeddings 140.

In turn, categorization apparatus 102 and/or another component of the system uses clusters 142 of related words to generate incident categories 114 to which the incident tickets can be assigned. For example, the component may assign a numerical category to each cluster generated by categorization apparatus 102 from embeddings 140. In a second example, the component may select a word in a cluster as a “representative” category name for the corresponding incident category. In a third example, the component may assign two or more clusters 142 to the same category based on overlap in words between or among the clusters.

In a fourth example, the component may obtain mappings and/or assignments of clusters 142 to predefined incident categories 114 from an administrator and/or other user associated with ITSM system 132. An example mapping of names of incident categories 114 to clusters 142 of related words includes the following:

| Category | Related Words |
|---|---|
| Hardware | ‘connects’, ‘faulty’, ‘charging’, ‘break’, ‘turning’, ‘bad’, |
| | ‘plantronics’, ‘dead’, ‘intermittently’, ‘plug’, ‘charge’, |
| | ‘turns’, ‘headset’, ‘water’, ‘dropped’, ‘headphones’, ‘little’, |
| | ‘speakers’, ‘switching’, ‘intermittent’, ‘broken’, ‘sound’, |
| | ‘functioning’, ‘loose’, ‘broke’, ‘loud’, ‘playing’, ‘pad’, |
| | ‘recognizing’, ‘battery’, ‘touchpad’, ‘lower’, ‘powering’, |
| | ‘signal’, ‘plugged’, ‘light’, ‘bluetooth’, ‘turn’, ‘powered’, |
| | ‘trackpad’, ‘speaker’, ‘unplugged’, ‘flickering’, ‘noise’, |
| | ‘headphone’ |
| Authen- | ‘passcode’, ‘registered’, ‘enroll’, ‘proactive’, ‘registering’, |
| tication | ‘authentication’, ‘finish’, ‘register’, ‘mfa’, ‘enrollment’, |
| | ‘factor’, ‘verification’, ‘auth’, ‘reg’, ‘authenticator’, |
| | ‘qr’, ‘phoneregistration’, ‘multi’, ‘pin’ |
| Email | ‘spam’, ‘messages’, ‘whitelist’, ‘permanently’, ‘marked’, |
| | ‘mail’, ‘rule’, ‘forwarding’, ‘rules’, ‘recipient’, ‘sender’, |
| | ‘mailbox’, ‘confirmation’, ‘email’, ‘junk’ |
| Browsers | ‘chrome’, ‘incognito’, ‘safari’, ‘browser’, ‘browsers’, |
| | ‘cookies’, ‘mozilla’, ‘edge’, ‘firefox’, ‘tabs’, ‘cleared’ |
| Laptops | ‘asset’, ‘lenovo’, ‘carbon’, ‘i7’, ‘x240’, ‘model’, ‘x1’, |
| | ‘x230’, ‘yoga’, ‘z620’, ‘gen2’, ‘gen1’, ‘z640’, ‘serial’, |
| | ‘hp’ |
| Phones | ‘airwatch’, ‘devices’, ‘iphone’, ‘agent’, ‘mobile’, ‘enrolled’, |
| | ‘apple’, ‘device’, ‘android’, ‘ios’ |

After incident categories 114 are assigned to clusters 142, the responsible system component stores mappings of incident categories 114 to embeddings 140, clusters 142, and/or words in clusters 142 in incident repository 134 and/or another data store. The component may also, or instead, provide incident categories 114 and/or words in each incident category to classification apparatus 108, management apparatus 110, and/or other components of the system for use with subsequent incident tickets received by ITSM system 132.

In one or more embodiments, classification apparatus 108 calculates match scores 112 between incident tickets and incident categories 114 based on occurrences of related words from clusters 142 in the incident tickets. For example, classification apparatus 108 may obtain mappings of incident categories 114 to clusters 142 of related words from categorization apparatus 102, incident repository 134, and/or another source. When a new incident ticket is received by ITSM system 132 and/or in incident repository 134, classification apparatus 108 may perform stemming and/or removal of stop words and infrequent words from the incident ticket. Classification apparatus 108 may then calculate a match score between remaining words in the incident ticket and each incident category as the number of occurrences of words from the cluster represented by the incident category in the incident ticket. Classification apparatus 108 may also, or instead, calculate the match score as a measure of distance between embeddings of the remaining words in the incident ticket and words in the cluster.

Classification apparatus 108 uses match scores 112 between each incident ticket and incident categories 114 to assign one or more incident categories 114 to the incident ticket. For example, classification apparatus 108 may assign the incident category 114 with the highest match score to the incident ticket. In another example, classification apparatus 108 and/or another component of the system may display a subset of incident categories 114 with highest match scores 112 (e.g., the three highest-scoring incident categories 114 for a given incident ticket) to a user (e.g., an agent), and the user may select one of the incident categories as the incident category to assign to the incident ticket. Alternatively, the user may override the displayed incident categories 114 with a manual selection of an incident category that is not one of the highest-scoring incident categories 114. After an incident category is selected for an incident ticket, classification apparatus 108 stores a mapping of the incident ticket to the incident category in incident repository 134 and/or another data store.

Management apparatus 110 then generates routings 144 of incident tickets to agents and/or groups of agents according to incident categories 114 assigned to the incident tickets. For example, management apparatus 110 may assign each incident ticket to an agent and/or group of agents with experience and/or expertise in handling issues described in the incident ticket. Management apparatus 110 may also update incident repository 134 and/or another data store with the assignment of the ticket to the agent(s).

Management apparatus 110 additionally collects feedback 146 related to incident categories 114 and/or routings 144 of the incident tickets, and management apparatus 110 and/or another component of the system updates clusters 142 and/or incident categories 114 based on feedback 146.

For example, feedback 146 may include selections of incident categories 114 for the incident tickets by agents and/or manual overrides to assignments of incident categories 114 to incident tickets made by classification apparatus 108. The component may label the incident tickets with incident categories 114 from feedback 146. The component may also use the labels to recreate clusters 142, add words to clusters 142, remove words from clusters 142, add or remove assignments of clusters to incident categories 114, create new clusters 142, delete existing clusters 142, merge two or more clusters 142, separate a cluster into two or more clusters 142, and/or otherwise reorganize clusters 142 and/or incident categories 114.

In turn, the newest clusters 142 and/or incident categories 114 may be used by categorization apparatus 102 and/or classification apparatus 108 to generate subsequent match scores 112 and/or assignments of incident categories 114 to incident tickets. As a result, the accuracy of incident categories 114 assigned to the incident tickets may improve over time.

By identifying and categorizing semantic similarities among words in incident tickets and performing classification and routing of the incident tickets based on the semantic similarities, the disclosed embodiments may perform incident management in the context of organizations and/or domains in which the incidents occur, thereby improving the accuracy and efficiency with which the incident tickets are routed and handled. In contrast, conventional techniques may perform manual, generic, and/or rule-based classification of the incident tickets, which can be erroneous and delay subsequent resolution of the corresponding issues. Consequently, the disclosed embodiments may improve computer systems, applications, user experiences, tools, and/or technologies related to incident classification and/or IT service management.

Those skilled in the art will appreciate that the system of FIG. 1 may be implemented in a variety of ways. First, categorization apparatus 102, classification apparatus 108, management apparatus 110, and/or incident repository 134 may be provided by a single physical machine, multiple computer systems, one or more virtual machines, a grid, one or more databases, one or more filesystems, and/or a cloud computing system.

Categorization apparatus 102, classification apparatus 108, and/or management apparatus 110 may additionally be implemented together and/or separately by one or more hardware and/or software components and/or layers.

Second, the functionality of categorization apparatus 102 and/or classification apparatus 108 may be implemented using a number of techniques. For example, the functionality of word embedding model 138 may be provided by a Large-Scale Information Network Embedding (LINE), principal component analysis (PCA), latent semantic analysis (LSA), and/or other technique that generates a low-dimensional embedding space from documents and/or terms. Multiple versions of word embedding model 138 may also be adapted to different subsets of incident tickets and/or users, or the same word embedding model 138 may be used to generate embeddings 140 for all users and/or incident tickets. In another example, incident categories 114 may be defined and/or assigned to incident tickets using an artificial neural network, Naïve Bayes classifier, Bayesian network, regression model, deep learning model, support vector machine, decision tree, random forest, hierarchical model, ensemble model, and/or other type of machine learning model or technique.

Third, the system may be adapted to different types of content and/or categories. For example, the functionality of the system may be used to classify, organize, and/or route customer service tickets, bug reports, surveys, reviews, articles, social media posts, and/or other types of content for subsequent processing of the content and/or management of issues described in the content.

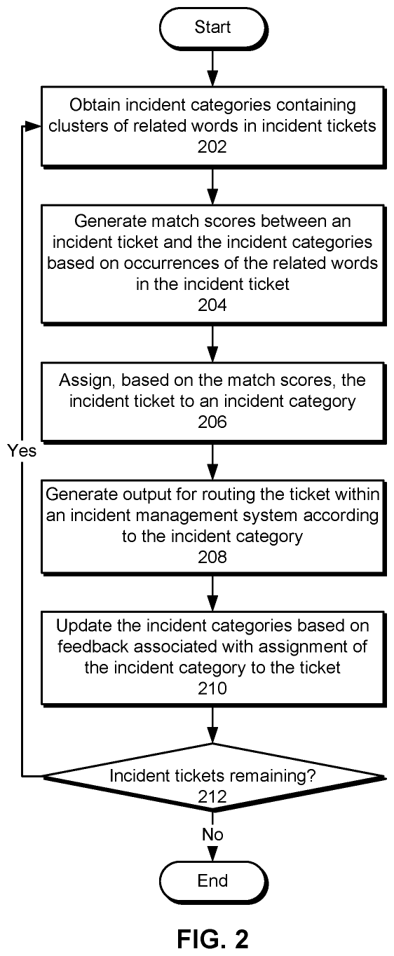

FIG. 2 shows a flowchart illustrating a process of classifying and routing enterprise incident tickets in accordance with the disclosed embodiments. In one or more embodiments, one or more of the steps may be omitted, repeated, and/or performed in a different order. Accordingly, the specific arrangement of steps shown in FIG. 2 should not be construed as limiting the scope of the embodiments.

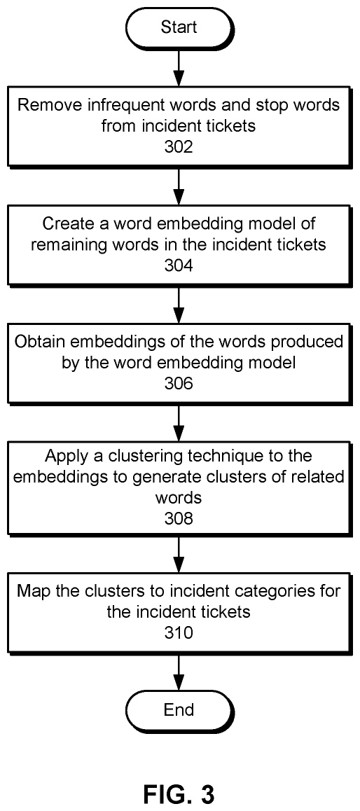

Initially, incident categories containing clusters of related words in incident tickets are obtained (operation 202), as described in further detail below with respect to FIG. 3. Next, match scores between an incident ticket and the incident categories are generated based on occurrences of the related words in the incident ticket (operation 204). For example, a match score between the incident ticket and an incident category may represent the number of times a word in a cluster represented by the incident category is found in the incident ticket. As a result, the match score may be incremented whenever a word in the cluster is found in the incident ticket.

The incident ticket is then assigned to an incident category based on the match scores (operation 206). For example, the incident ticket may be assigned to the incident category associated with the highest match score. In another example, a subset of incident categories with the highest match scores may be displayed within a user interface (e.g., graphical user interface, web-based user interface, command line interface, etc.), and a selection of the incident category within the displayed subset of incident categories may be obtained through the user interface.

Output for routing the ticket within an incident management system according to the incident category is generated (operation 208). For example, the incident category may be stored in association with the incident ticket within the incident management system to indicate assignment of the incident ticket to the incident category. In another example, the incident ticket may be routed to an agent associated with the incident category.

Finally, the incident categories are updated based on feedback associated with assignment of the incident category to the ticket (operation 210). For example, user selection or confirmation of the incident category for the incident ticket may be used to add and/or remove words in the cluster represented by the incident category and/or reorganize clusters associated with the incident categories.

Operations 202-210 may be repeated for remaining incident tickets (operation 212). For example, incident categories may be assigned to each new incident ticket received through the incident management system, and incident tickets may be routed within the incident management system according to the assigned incident categories to streamline resolution of issues associated with the incident tickets. Feedback related to the assignments may additionally be used to improve the accuracy of the incident categories and/or assignments of subsequent incident tickets to the incident categories.

FIG. 3 shows a flowchart illustrating a process of generating incident categories for incident tickets in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the embodiments.

Initially, infrequent words and stop words are removed from the incident tickets (operation 302). For example, a large set (e.g., tens or hundreds of thousands) of incident tickets may be filtered to exclude words that occur less than 100 times, high-frequency words, names, locations, and/or numbers from the incident tickets. Stemming may also be performed on remaining words in the incident tickets to remove inflections from the words.

Next, a word embedding model of remaining words in the incident tickets is created (operation 304), and embeddings of the words produced by the word embedding model are obtained (operation 306). For example, a word2vec model may be trained using documents containing the remaining words, so that embeddings produced by the word2vec model reflect semantic relationships among words in the incident tickets.

A clustering technique is then applied to the embeddings to generate clusters of related words (operation 308). For example, k-means clustering of the embeddings may be performed to produce a pre-defined number of clusters from words inputted into the word embedding model.

Finally, the clusters are mapped to incident categories for the incident tickets (operation 310). For example, each cluster may be assigned to a different category number and/or identifier. In another example, mappings of some or all of the clusters to predefined incident categories (e.g., machine types, projects, issue types, hardware categories, software categories, and/or other categories related to ITSM) may be obtained from an administrator and/or another user of an incident management system. The clusters and incident categories may then be used to classify and route incident tickets in the incident management system, as discussed above.

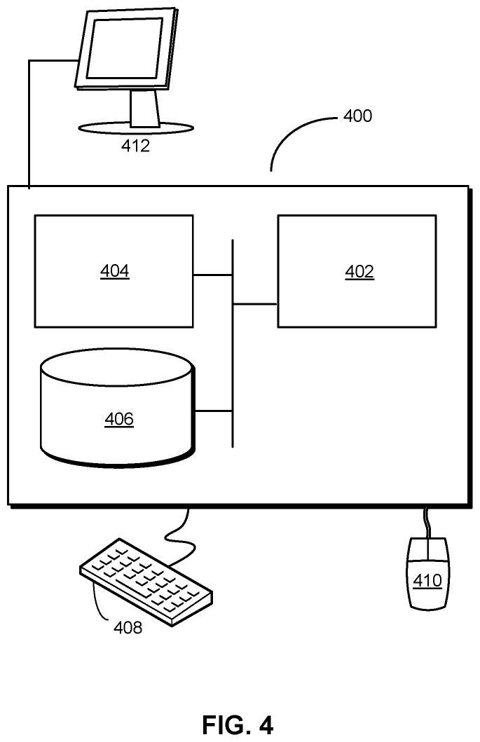

FIG. 4 shows a computer system 400 in accordance with the disclosed embodiments. Computer system 400 includes a processor 402, memory 404, storage 406, and/or other components found in electronic computing devices. Processor 402 may support parallel processing and/or multi-threaded operation with other processors in computer system 400. Computer system 400 may also include input/output (I/O) devices such as a keyboard 408, a mouse 410, and a display 412.

Computer system 400 may include functionality to execute various components of the present embodiments. In particular, computer system 400 may include an operating system (not shown) that coordinates the use of hardware and software resources on computer system 400, as well as one or more applications that perform specialized tasks for the user. To perform tasks for the user, applications may obtain the use of hardware resources on computer system 400 from the operating system, as well as interact with the user through a hardware and/or software framework provided by the operating system.

In one or more embodiments, computer system 400 provides a system for classifying and routing incident tickets. The system includes a categorization apparatus, a classification apparatus, and a management apparatus, one or more of which may alternatively be termed or implemented as a module, mechanism, or other type of system component. The categorization apparatus obtains incident categories containing clusters of related words in incident tickets. Next, the classification apparatus generates match scores between an incident ticket and the incident categories based on occurrences of the related words in the incident ticket. The classification apparatus then assigns, based on the match scores, the incident ticket to an incident category in the incident categories. Finally, the management apparatus generates output for routing the incident ticket within an incident management system according to the incident category

In addition, one or more components of computer system 400 may be remotely located and connected to the other components over a network. Portions of the present embodiments (e.g., categorization apparatus, classification apparatus, management apparatus, incident repository, enterprise system, etc.) may also be located on different nodes of a distributed system that implements the embodiments. For example, the present embodiments may be implemented using a cloud computing system that classifies and routes enterprise incident tickets from a set of remote users of an enterprise system.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor (including a dedicated or shared processor core) that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
obtaining incident categories comprising clusters of related words in incident tickets, wherein the clusters of related words are generated based on embeddings of words in the incident tickets;
generating, by one or more computer systems, match scores between an incident ticket and the incident categories based on occurrences of the related words in the incident ticket;
assigning, by the one or more computer systems based on the match scores, the incident ticket to an incident category in the incident categories; and
generating output for routing the incident ticket within an incident management system according to the incident category.

2. The method of claim 1, wherein obtaining the incident categories comprising the clusters of related words in the incident tickets comprises:
creating a word embedding model of the words in the incident tickets; and
generating the incident categories and the clusters of related words in the incident tickets based on the embeddings produced by the word embedding model.

3. The method of claim 2, wherein obtaining the incident categories comprising the clusters of related words in the incident tickets further comprises:
removing infrequent words and stop words from the incident tickets prior to creating the word embedding model from the incident tickets.

4. The method of claim 3, wherein the stop words comprise at least one of:
a high-frequency word;
a name;
a location; and
a number.

5. The method of claim 2, wherein generating the incident categories and the clusters of related words in the incident tickets based on the embeddings produced by the word embedding model comprises:
applying a clustering technique to the embeddings to generate the clusters of related words; and
mapping the clusters of related words to the incident categories.

6. The method of claim 1, wherein generating the match scores between the incident ticket and the incident categories based on occurrences of the related words from the clusters in the incident ticket comprises:
incrementing a match score between the incident ticket and another incident category when a word from a cluster represented by the other incident category is found in the incident ticket.

7. The method of claim 1, further comprising:
updating the incident categories based on feedback associated with assignment of the incident category to the incident ticket.

8. The method of claim 1, wherein assigning the incident ticket to the incident category comprises:
displaying, within a user interface, a subset of the incident categories with highest match scores in the match scores; and
obtaining, through the user interface, a selection of the incident category within the displayed subset of the incident categories.

9. The method of claim 1, wherein assigning the incident ticket to the incident category comprises:
assigning the incident category associated with a highest match score to the incident ticket.

10. The method of claim 1, wherein generating output for routing the incident ticket within the incident management system according to the incident category comprises at least one of:
storing the incident category in association with the incident ticket; and
routing the incident ticket to an agent associated with the incident category.

11. The method of claim 1, wherein the incident categories comprise at least one of:
a machine type;
a project;
an issue type;
a hardware category; and
a software category.

12. A system, comprising:
one or more processors; and
memory storing instructions that, when executed by the one or more processors, cause the system to:
obtain incident categories comprising clusters of related words in incident tickets, wherein the clusters of related words are generated based on embeddings of words in the incident tickets;
generate match scores between an incident ticket and the incident categories based on occurrences of the related words in the incident ticket;
assign, based on the match scores, the incident ticket to an incident category in the incident categories; and
generate output for routing the incident ticket within an incident management system according to the incident category.

13. The system of claim 12, wherein obtaining the incident categories comprising the clusters of related words in the incident tickets comprises:
creating a word embedding model of the words in the incident tickets; and
generating the incident categories and the clusters of related words in the incident tickets based on the embeddings produced by the word embedding model.

14. The system of claim 13, wherein obtaining the incident categories comprising the clusters of related words in the incident tickets further comprises:
removing infrequent words and stop words from the incident tickets prior to creating the word embedding model from the incident tickets.

15. The system of claim 13, wherein generating the incident categories and the clusters of related words in the incident tickets based on the embeddings produced by the word embedding model comprises:
applying a clustering technique to the embeddings to generate the clusters of related words; and
mapping the clusters of related words to the incident categories.

16. The system of claim 12, wherein generating the match scores between the incident ticket and the incident categories based on occurrences of the related words from the clusters in the incident ticket comprises:
incrementing a match score between the incident ticket and another incident category when a word from a cluster represented by the other incident category is found in the incident ticket.

17. The system of claim 12, wherein the memory further stores instructions that, when executed by the one or more processors, cause the system to:
update the incident categories based on feedback associated with assignment of the incident category to the incident ticket.

18. The system of claim 12, wherein assigning the incident ticket to the incident category comprises:
displaying, within a user interface, a subset of the incident categories with highest match scores in the match scores; and
obtaining, through the user interface, a selection of the incident category within the displayed subset of the incident categories.

19. A non-transitory computer-readable storage medium storing instructions that when executed by a computer cause the computer to perform a method, the method comprising:
obtaining incident categories comprising clusters of related words in incident tickets, wherein the clusters of related words are generated based on embeddings of words in the incident tickets;
generating match scores between an incident ticket and the incident categories based on occurrences of the related words in the incident ticket;
assigning, based on the match scores, the incident ticket to an incident category in the incident categories; and
generating output for routing the incident ticket within an incident management system according to the incident category.

20. The non-transitory computer-readable storage medium of claim 19, wherein obtaining the incident categories comprising the clusters of related words in the incident tickets comprises:
creating a word embedding model of the words in the incident tickets;
applying a clustering technique to the embeddings produced by the word embedding model to generate the clusters of related words; and
mapping the clusters of related words to the incident categories.
